(19) United States
(12) Patent Application Publication
(10) Pub. No.: US 2003/0163366 A1
(43) Pub. Date: Aug. 28, 2003

(54) Method and apparatus for organizing information and conducting thematic inquiry

(76) Inventor: Frederick I Taft, Pepper Pike, OH (US)

Correspondence Address: PEARNE & GORDON LLP, 526 SUPERIOR AVENUE EAST, SUITE 1200, CLEVELAND, OH, 44114-1484, US

(21) Appl. No.: 10/297,025

(22) PCT Filed: May 25, 2001
(86) PCT No.: PCT/US01/40817

(51) Int. Cl. G06F 17/60

(52) U.S. Cl. 705/12

(57) ABSTRACT

A software-based system for organizing information and conducting thematic inquiry using inductive analysis of material from multiple sources. The user gathers material on a chosen topic from multiple sources and for each source composes ideas that express the key concepts found in the source material. The software automatically pools the ideas from all the sources and presents them in a particular display format supported by a graphical organizing capacity; the goal is to aid the user in abstracting from these ideas a smaller group of distilled ideas which express the themes or commonalities within the pool. The software then presents the distilled ideas in the same display format supported by the same graphical organizing capacity so that the user may abstract a smaller group of ultradistilled ideas which express the themes or commonalities within the distilled ideas. Through this iterative, inductive process the user creates an idea pyramid—a pyramid of progressively distilled thought and thematic expression built on a base of source material. A user can trace back from an ultradistilled idea at the apex, through the associated distilled ideas to the associated ideas in the pool, and from there to the source material from which the ideas in the pool were derived. The system enables the user to discern thematic order in complex and sprawling data from heterogeneous sources. In a network environment, differentiated interaction privileges would permit building around the idea pyramid a web of commentary, amendment, polling, deepening inquiry in a comparable format, etc.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF THE INVENTION

A high-level function of human intelligence is to discern meaningful conceptual patterns in diverse qualitative data. The present invention assists that function by providing a graphically-structured software tool for organizing information and conducting thematic inquiry.

### BACKGROUND OF THE INVENTION

While the human brain has remarkable powers of conceptual pattern recognition when faced with heterogeneous qualitative data, it is relatively difficult for the unaided brain (i) to retain in active memory and to discern patterns in large bodies of qualitative data and (ii) to consolidate what is learned from sprawling data at one level of qualitative inquiry as a base for further inquiry at a more abstract level. The present invention supports the user's analytical process by helping do these two things which the brain has a hard time doing alone.

### SUMMARY OF THE INVENTION

The invention provides a method and apparatus for organizing information and conducting thematic inquiry. The method includes the steps of listing ideas to form a pool of ideas; graphically organizing the ideas into thematic groups; then composing distilled ideas and graphically associating ideas in the pool with distilled ideas, wherein each distilled idea expresses a theme common to that thematic group of ideas from the pool that is associated with said distilled idea. The method further comprises the steps of graphically organizing the distilled ideas into thematic groups, then composing ultradistilled ideas and graphically associating distilled ideas with ultradistilled ideas, wherein each ultradistilled idea expresses a theme common to that thematic group of distilled ideas that is associated with said ultradistilled idea. The apparatus provides means for facilitating and performing the method steps.

According to another aspect, the invention includes the steps of listing ideas to form a pool of ideas; composing distilled ideas and associating each idea in the pool with a distilled idea, wherein each distilled idea expresses a theme common to those ideas from the pool that are associated with said distilled idea; then composing ultradistilled ideas and associating each distilled idea with an ultradistilled idea, wherein each ultradistilled idea expresses a theme common to those distilled ideas that are associated with said ultradistilled idea. The apparatus provides means for facilitating and performing the method steps.

The present invention further provides a method and apparatus for (i) storing a large body of qualitative data and baseline concepts derived from that data, (ii) graphically organizing the concepts into thematic groups in a way that supports pattern recognition and idea expression and (iii) using ideas developed at one level of inquiry as a base for continued analysis, pattern recognition and idea expression at progressively higher levels of abstraction. Use of the invention leads in an inductive, iterative fashion to the creation of an idea pyramid—a pyramid of progressively distilled thought built on a base of source material.

This method sacrifices detail for overview as the level of abstraction rises, but the sequence can also be reversed in that the user of a pyramid of ideas structured with this invention can choose to drill down into the pyramid from more general statements at the apex to the more detailed material from which the general statements were derived. The depths of the pyramid can contain not only the data from which the general statements were derived, but also references or links to other data sources.

The invention's format tends to perpetuate rather than purge latent conflicts in the underlying data; it fosters summary and condensation, but is open to the presentation of competing ideas without the choice of a winner. The invention helps the user bring to the surface and clarify broad gauge patterns, whether complementary or conflicting, so that the user can better understand the points being made and address them as he or she may choose.

The idea pyramid for which the present invention provides a software-based architecture will ordinarily be built out of words. This mode suits well the many domains where most knowledge is framed verbally. Even in domains where critical knowledge is framed principally in numbers, images, formulae, etc., there is commonly an overlay of verbal thought where this invention's analytical format may prove useful. Non-verbal material can function as source material from which baseline ideas can be drawn for the conceptual distillation process which this invention invites. Also, once the textual idea pyramid has taken shape, non-verbal material can be linked to it wherever appropriate. An advanced application of the present invention would involve presentation of source data in a non-verbal mode, such as photography or abstract design, and pursuit of the conceptual distillation and thematic inquiry process within that medium.

The invention, when embodied in software running in an appropriate computing environment, can organize information in a way which aids analysis and insight by individuals and which is widely intelligible by and helps build consensus among the members of a group.

### BRIEF DESCRIPTION OF THE DRAWINGS

FIG. 1 presents a flowchart of actions by the user of software which embodies the invention.

FIG. 2 presents a schematic description of the pyramid of progressively distilled thought in which a more abstract and succinct apex is distilled in two stages from a more detailed and inclusive bottom layer made up of ideas drawn from a base of source material.

FIG. 3 shows (without illustrative data) the initial Idea Pyramids screen where the user can choose among two left sidebar buttons to see a list of idea pyramids or to create a new one.

FIG. 4 shows the Create Idea Pyramid dialogue box which appears when the user clicks on the Create Idea Pyramid button in the sidebar or on the appropriate icon in the toolbar within the Idea Pyramids screen.

FIG. 5 shows the Idea Pyramids screen after a sample idea pyramid has been created.

FIG. 6 shows the Sources screen which appears when the user double clicks on an idea pyramid name in the Idea Pyramids screen or clicks on the Modify Idea Pyramid icon in the toolbar within the Ideas Pyramids screen. This screen displays the names of sources for whom source profiles have been created within the idea pyramid.

FIG. 7 shows the Graphic Count screen which appears when the user clicks on the Graphic Count button in the sidebar. This screen has a graphic presentation of the four main elements of the idea pyramid and the number of items entered at each level.

FIG. 8 shows the Glossary screen which appears when the user clicks on the Glossary button in the sidebar.

FIG. 9 shows the Create Source screen which appears when the user clicks on the Create Source button in the sidebar or on the appropriate icon in the toolbar within the Sources screen.

FIG. 10 shows the Source Profile screen which appears when the user double-clicks on the name of a source on the Sources screen or clicks on the icon to modify a Source Profile in the toolbar within the Sources screen.

FIG. 11 shows the Linkages dialogue box which appears when the user clicks on the Linkages icon in the toolbar for the Notes field in the Source Profile screen.

FIG. 12 shows the Create Idea dialogue box which appears when the user clicks on the Create Idea icon in the toolbar for the Ideas field within the Source Profile Screen.

FIG. 13 shows the Score Descriptions dialogue box which appears when the user clicks on the Score Descriptions option in the pull-down menu under the Tools category in the standard menu bar.

FIG. 14 shows the Modify Idea dialogue box with the Linkages feature accessible which appears when the user clicks on the Modify Idea icon in the toolbar for the Ideas field of the Source Profile screen.

FIG. 15 shows the Pool of Ideas screen which appears when the user clicks on the Pool of Ideas button in the sidebar.

FIG. 16 shows the Distilled Ideas screen which appears when the user clicks on the Distilled Ideas button in the sidebar.

FIG. 17 shows the Unassigned Ideas from the Pool-Graphic Sort screen which appears when the user clicks on the Graphic Sort icon in the toolbar for the Unassigned Ideas from the Pool field in the Distilled Ideas screen.

FIG. 18 shows the Modify Graphic Sort Options dialogue box which appears when the user clicks on the Modify Graphic Sort Options icon in the toolbar for the Unassigned Ideas from the Pool—Graphic Sort screen.

FIG. 19 shows the dialogue box entitled “Highlight the text you want to display in the Graphic Sort Screen” which appears when the user double clicks on an idea in the upper field of the Unassigned Ideas from the Pool—Graphic Sort screen.

FIG. 20 shows the Distilled Screen with entries that illustrate how the opposition box can be toggled for an opposing idea and how the bar graph presented with each distilled idea can show both the percentage of source support and the percentage of support opposition.

FIG. 21 shows the Ultradistilled Ideas screen which appears when the user clicks on the Ultradistilled Ideas button in the sidebar.

FIG. 22 shows the View Ultradistilled Ideas screen which appears when the user clicks on the View UI button in the sidebar.

FIG. 23 shows the screen entitled “View Ultradistilled Ideas and Assigned Distilled Ideas and their Assigned Ideas from the Pool” which appears when the user clicks on the View UI & Assigned DI & UI button in the sidebar.

### PREFERRED EMBODIMENTS OF THE INVENTION

The invention is embodied in one or more related software programs which may be run on any compatible computer with customary features and sufficient data-handling capacity. The software programs will employ customary structural, iconographic and data-handling conventions as needed. The function of the invention and examples of its embodiments in computer software are discussed below with references to the figures.

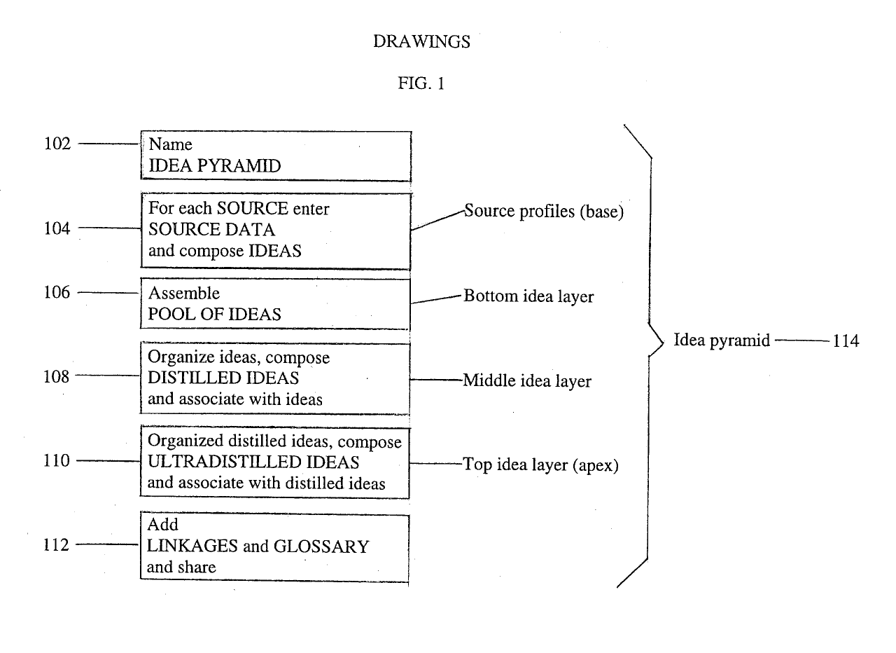

FIG. 1 presents a schematic illustration of the following sequence of user actions which the invention orchestrates through its software embodiment in a computing environment. The user creates and names 102 a new “idea pyramid” on a chosen topic, then enters 104 data gathered from relevant sources and from this data composes 104 for each source a set of key ideas. The data and ideas for each source constitute a “source profile”. The software automatically (a) gathers 106 the ideas from all the source profiles and lists them in a “pool of ideas” then (b) provides a mechanism to assist the user in (i) graphically organizing 108 the ideas into thematic groups, (ii) composing 108 a set of “distilled ideas” that express the themes, that is, the essential patterns and commonalities, which the user perceives in the thematic groups and (iii) graphically associating 108 the ideas in each thematic group with the distilled idea which expresses the theme perceived in that thematic group. The software then takes the list of distilled ideas as a starting point and employs the same paradigm to assist the user in (i) graphically organizing 110 the distilled ideas into thematic groups, (ii) composing 110 a set of “ultradistilled ideas” and (iii) graphically associating 110 the distilled ideas in each thematic group with the ultradistilled idea which expresses its theme. The user can forge an electronic link 112 from any idea in the idea pyramid or from the source data to any other information within the user's computer or available on a network. Each idea pyramid has its own glossary 112. The idea pyramid as a computer file 114 includes source profiles, the pool of ideas, the distilled ideas, the ultradistilled ideas and all linkages, supplemental information and ancillary files, such as the glossary. The user can share the idea pyramid over the internet or any other network and selectively permit others to view its content or to comment, vote, amend, link, etc. Users can also share glossaries and source profiles.

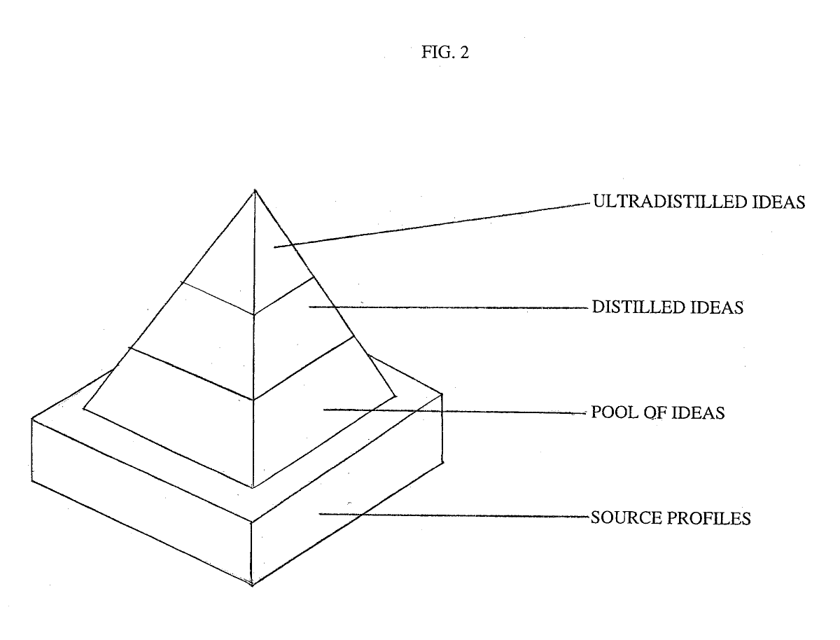

The source profiles, the pool of ideas, the distilled ideas and the ultradistilled ideas are visually presented as forming a pyramidal unit (see FIG. 2) in which the source profiles constitute a rectangular base and the three idea layers are seated on the base to form a pyramid of sloping sides.

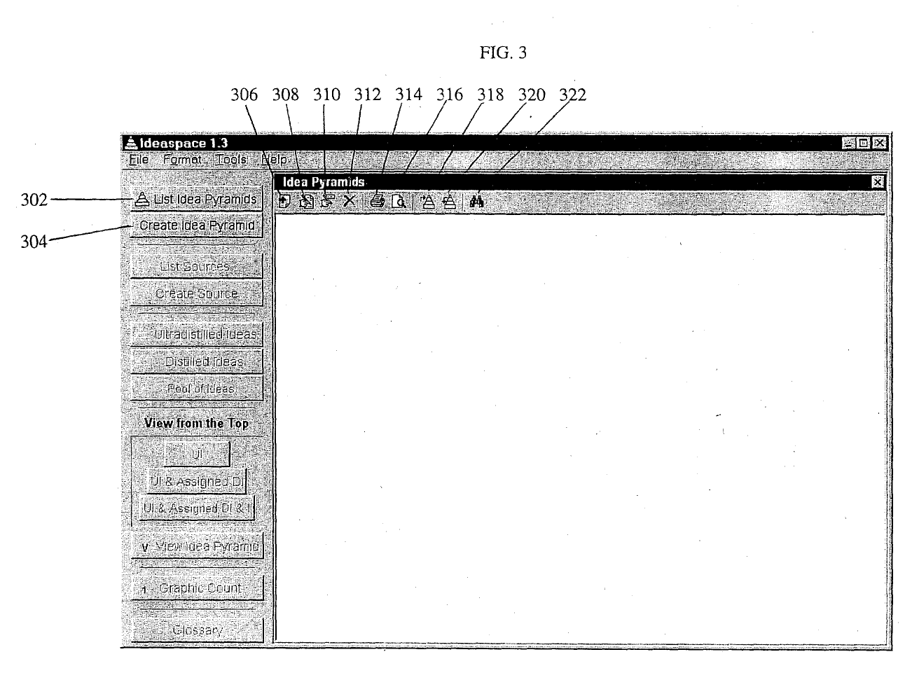

The computer screens shown in FIG. 3 through FIG. 23, which illustrate the preferred embodiments of the invention, are taken from an information-organizing software program named Ideaspace™. The method defined in this invention could be embodied in a variety of other software forms. In the Ideaspace software embodiment and in most places in the description of it provided herein, the particular term “assign” has been adopted to express the more general concept of associating an idea in a thematic group with a distilled idea which expresses the group's theme (or associating a distilled idea in a thematic group with an ultradistilled idea which expresses the group's theme).

FIG. 3 shows the screen which is presented when a user opens the software; this screen has a data field in which the user will over time enter the names of idea pyramids created on various topics. A standard left sidebar appears in this screen and in all other working screens within the software, but before an idea pyramid is open the only undimmed buttons on the sidebar are “List Idea Pyramids” 302 and “Create Idea Pyramid” 304. A toolbar also appears below the Idea Pyramids title bar, directly above the data field. The icons in this tool bar designate buttons which allow the user to choose various functions. Icons 306 and 312 designate buttons used, respectively, to create or delete an idea pyramid. Icons 308 and 310 designate buttons for, respectively, (i) opening the idea pyramid and modifying its contents or (ii) modifying only the identifying information entered when the idea pyramid was created. Icons 314 and 316 designate buttons used, respectively, to print the full list of idea pyramids or to preview the list to be printed. Icons 318 and 320 designate buttons for the import or export of an idea pyramid file; when one of these buttons is chosen, a dialogue box appears that elicits the user's decisions as to the location where the file is to be found (for import) or sent (for export) and the name which is to be given to the file after the transfer. The final icon in the toolbar designates a button 322 which lets the user search the list of idea pyramid names for a specified word or phrase.

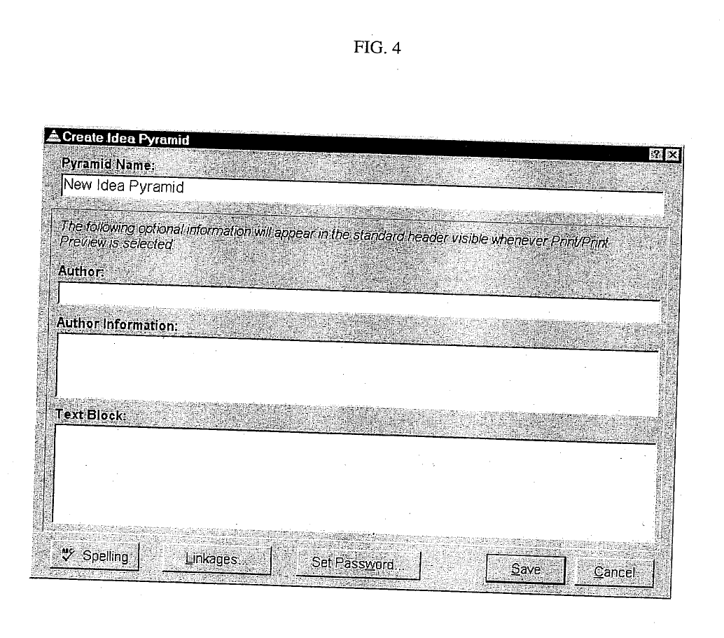

To create the first pyramid, the user chooses (by cursor placement and clicking) the “Create Idea Pyramid” button in the sidebar 304 or in the toolbar 306; whichever route is chosen, the same dialogue box is presented (see FIG. 4). The dialogue box lets the user enter, in appropriate fields, the name of the new idea pyramid, the author's name and address (or other key information), and a block of text, such as a disclaimer or description of the idea pyramid; the material entered in this dialogue box forms a standard header which appears when information drawn from this idea pyramid is previewed for printing or is printed.

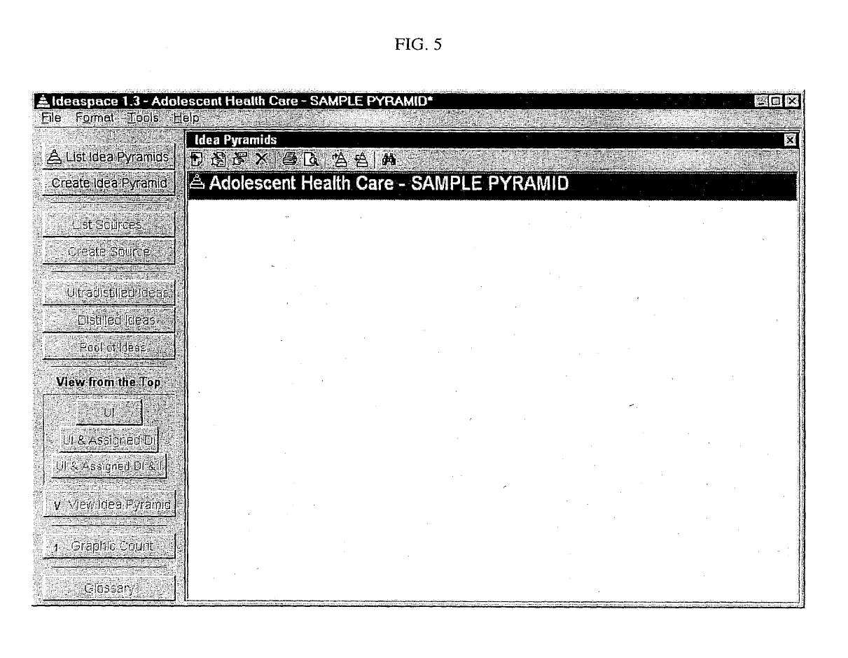

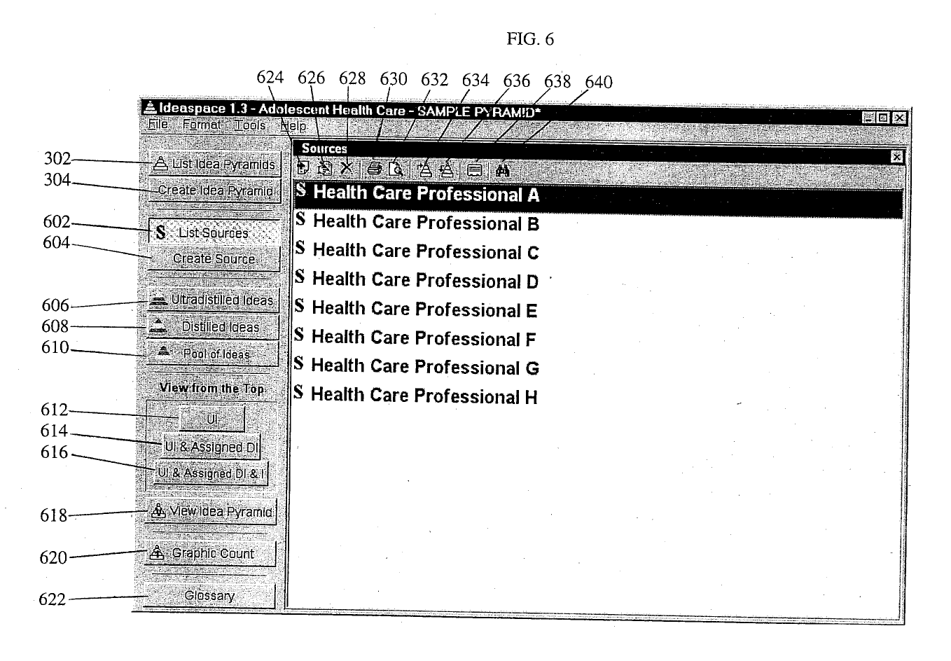

FIG. 5 shows the Idea Pyramids screen after a sample idea pyramid has been created. (In this Preferred Embodiments section and as illustrated in the preceding sentence, a reference to the name of a screen or a field is capitalized, while a reference to one of the items presented in the screen is not.) The user undertakes the process of building content for the idea pyramid by double-clicking on its name in the data field of the Idea Pyramids screen or clicking on the Modify Idea Pyramid icon 308 in the toolbar of the Idea Pyramids screen. This yields the Sources screen (see FIG. 6) in which the user will enter over time the names of all sources being used to develop the idea pyramid. FIG. 6 shows the Sources screen after several source files have been created within the sample idea pyramid. In the Sources screen and in all subsequent screens within the idea pyramid, all buttons on the sidebar are activated and undimmed.

The top button 302 on the sidebar lets the user go to the initial screen where all idea pyramids within the database are listed. The second button 304, as discussed above, lets the user create an idea pyramid. The remaining buttons can be used whenever an idea pyramid is open and permit rapid navigation to any point in the idea pyramid. The third and fourth buttons encountered moving down the sidebar take the user to the Sources screen (the button is entitled “List Sources” 602) or to a screen for the creation of a new source (“Create Source” 604). The next triad of buttons 606, 608, 610 gives the user access to each of the three idea levels of the idea pyramid; the buttons for these levels are ordered from the level of highest abstraction to the least: “Ultradistilled Ideas”, “Distilled Ideas”, and “Pool of Ideas”.

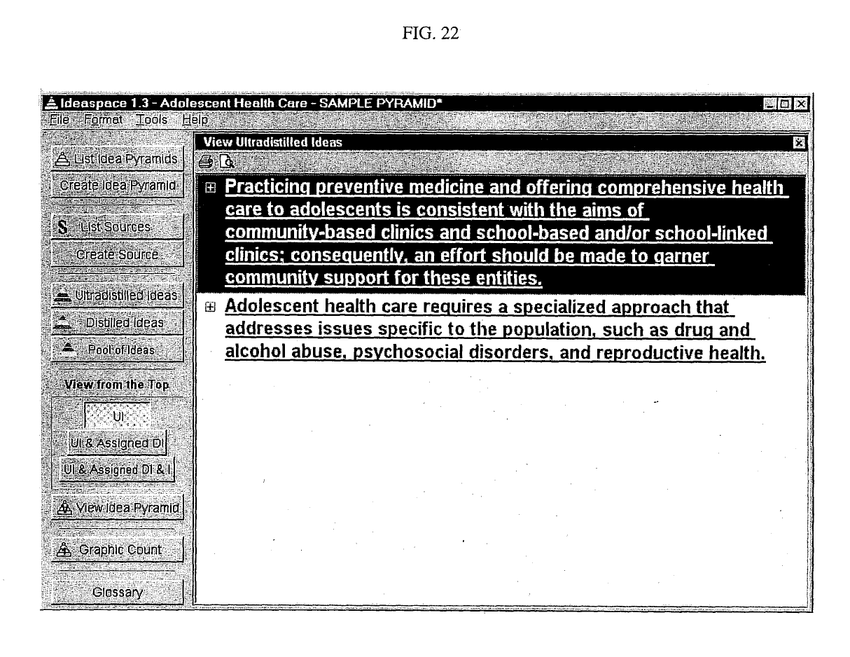

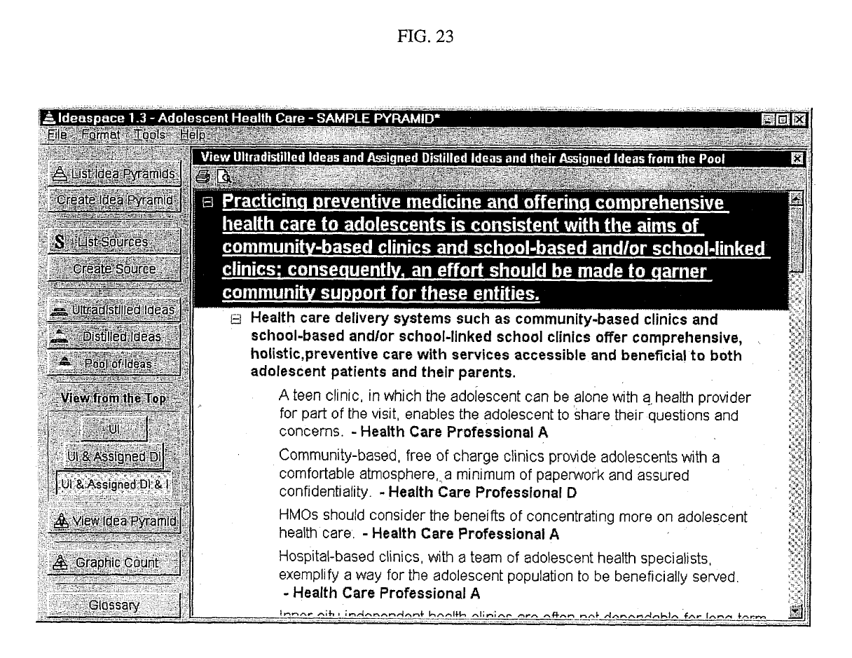

Next on the sidebar is a box entitled “View from the Top” containing three buttons 612, 614, 616 which allow the user a special top-down view in indented outline form of certain associated ideas in the idea pyramid. The ideas which can viewed through the use of these buttons are the ultradistilled ideas and the ideas which are associated with them in the two lower idea layers. The first button (“UI” 612) leads to a screen containing only the ultradistilled ideas. See FIG. 22. Choosing the next button (“UI & Assigned DI” 614) presents a view of the ultradistilled ideas and the distilled ideas which have been associated with or, to use the Ideaspace term, assigned to them. Choosing the third button in the box (“UI & Assigned DI & I” 616) presents a view of the ultradistilled ideas, the distilled ideas assigned to them (the “Assigned Distilled Ideas”) and the ideas from the pool of ideas which have been assigned to the Assigned Distilled Ideas. See FIG. 23. In the viewing screens to which these buttons lead, the user can through clicking on a plus/minus box at the beginning of distilled idea or through double-clicking on the distilled idea hide or reveal the associated ideas disposed adjacent to it; similarly, the user can opt at the ultradistilled level to hide or reveal distilled ideas and any revealed associated ideas disposed adjacent to them. Below View from the Top is a “View Idea Pyramid” button 618 which enables the user to display in print preview form all of the idea pyramid, including the glossary as an integral support file, or only selected parts of the whole.

These four view buttons on the sidebar embody a central concept: that the idea pyramid contains the user's full work product, including all assigned and unassigned ideas, and that the View from the Top provides a selective perspective into that work product from the apex of ultradistilled ideas down into the pyramid along lines of idea association. Phrased alternatively, the idea pyramid is a pyramid of progressively distilled thought built on a base of source material and the View from the Top looks down into that pyramid from the point of highest abstraction to see the emerging pattern of associated thought.

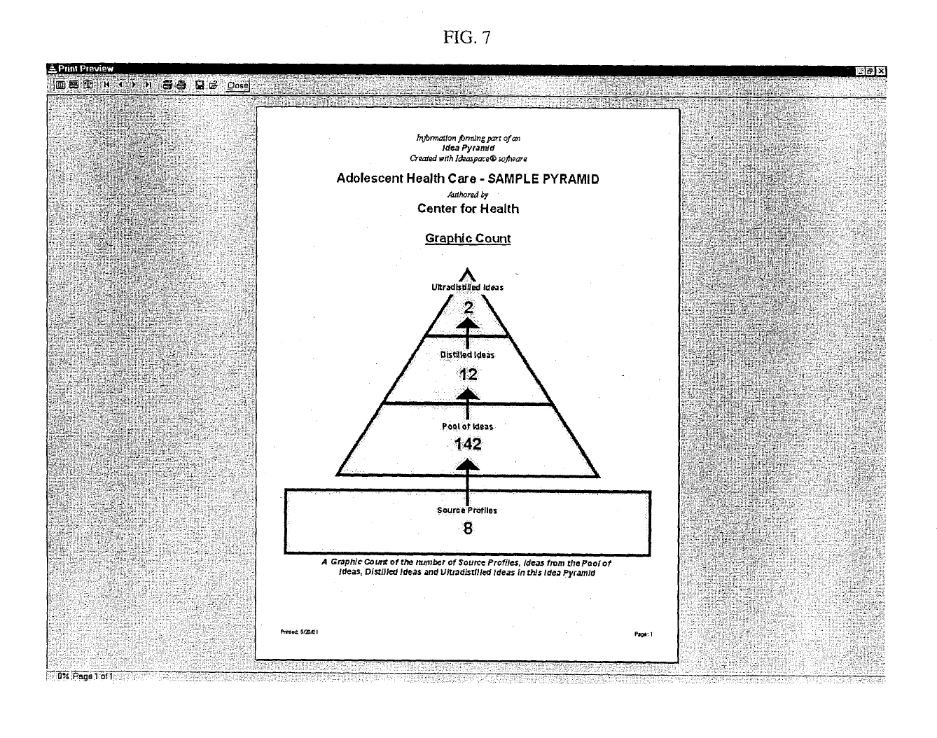

The next button down on the sidebar is “Graphic Count” 620; choosing this icon allows the user to view a graphic presentation of the full idea pyramid and the number of items which have been created (the number of sources in the source profiles base, and the number of ideas in each of the three idea layers). See FIG. 7. An advanced feature, which might be integrated with the basic software or made available as an independent service, would permit graphic enhancement of elements of the idea pyramid, perhaps as a large chart, a video presentation, an audience participation sequence or another specialized format.

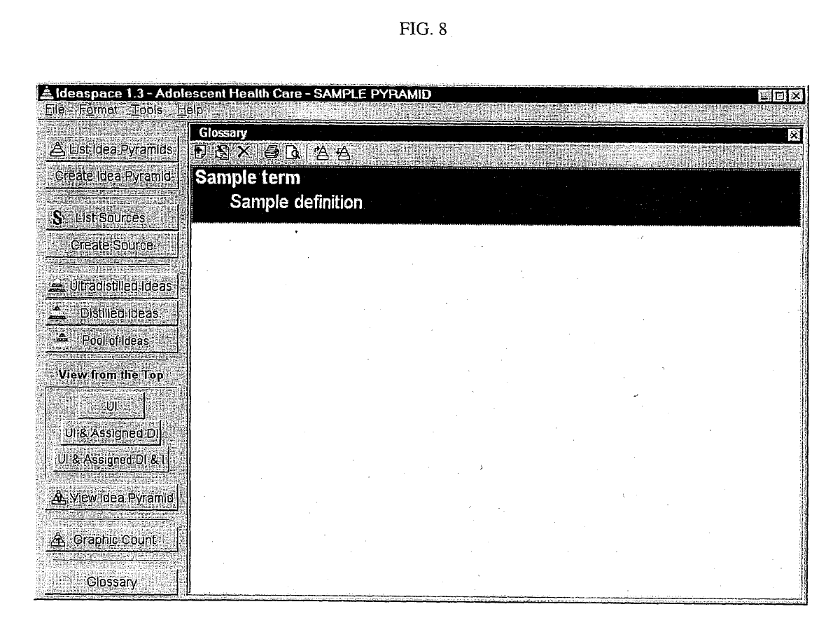

The last button on the sidebar is “Glossary” 622. See FIG. 8. To support the user's thought process at all phases of program use, the invention offers through this button ready access to a glossary which can include both customary electronic dictionary material and definitions of specialized terms developed by the user or made available over a network.

The sidebar is constant throughout the program; the horizontal toolbars vary with each screen. Within the Sources screen is a horizontal toolbar above the data field. See FIG. 6. Icons 624 and 628 designate buttons used, respectively, to create a new source or delete an existing one. Icon 626 designates a button for modifying the information entered for a source; when a source name has been selected (this is evidenced by its highlighting in the Sources screen) and the “Modify Source” icon 626 is chosen, the source profile for that source appears and new information can be entered. The source profile can also be opened by double-clicking on the source name in the Sources screen. Icons 630 and 632 designate buttons used, respectively, to print the full list of sources or to preview the list to be printed. Icons 634 and 636 designate buttons for the import or export of a source profile file; when one of these buttons is chosen, a dialogue box elicits the user's decisions as to the location where the file is to be found (for import) or sent (for export) and the name which is to be given to the file after the transfer.

The next icon 638 in the Sources screen toolbar designates a button which lets the user choose whether to show or hide for each of the listed sources any “source identity/bibliographic information” entered for that source in its source profile. If the user adopts a bibliographic form for the source identity data and elects to have it shown in the Sources screen rather than hidden, the Sources screen and any hard copy printed from it can function as a bibliography.

The final icon 640 in the Sources screen toolbar designates a button which lets the user search the list of sources for a specified word or phrase.

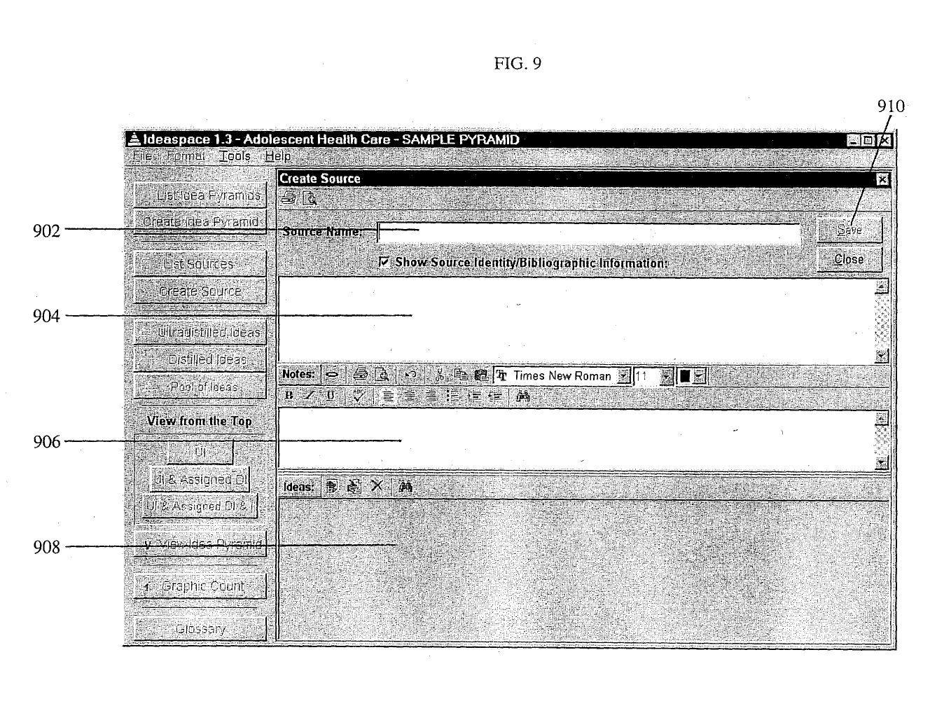

The user can elect to create a new source by clicking the “Create Source” button in the sidebar or the first icon in the Sources screen toolbar. In either case the Create Source screen appears (see FIG. 9) which provides (i) a field 902 for entering the name of the new source, (ii) a field 904for entering “source identity/bibliographic information”, which can be toggled to be shown or hidden, (iii) an open-ended field 906 for source data, which in the Ideaspace software is entitled “Notes”, and (iv) a field 908 in the lower part of the screen for “Ideas” associated with that source. The Notes field is the principal inflow channel and repository for useful data of any kind related to the source. Such data may be gathered through any effective means-academic research, interviews, solicited material, focus groups, depositions, etc.

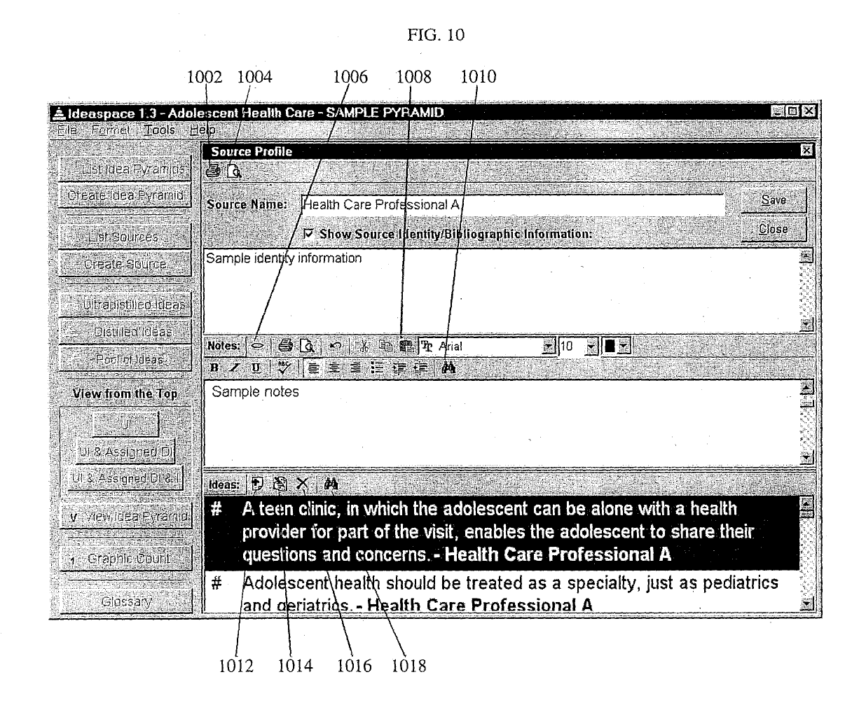

When the user has made for a new source an initial entry in the Create Source screen of at least a name, clicking on Save 910 will save the entry and establish a file for that source. When the user subsequently opens the file for that source, the Source Profile screen will appear. See FIG. 10. The data entry fields and toolbars which appear in the Create Source screen also appear, fully activated, in the Source Profile screen.

The uppermost toolbar in the Source Profile screen appears below the Source Profile title bar. It contains only icons which designate buttons for “Print” 1002 and “Print Preview” 1004, which function in a conventional manner.

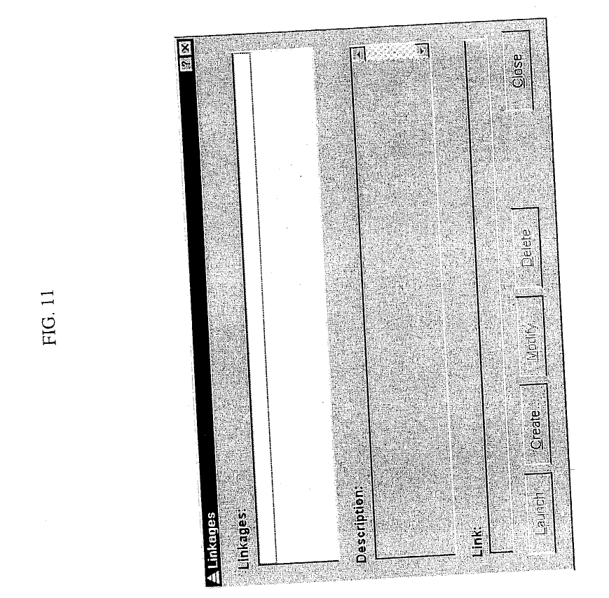

The toolbar above the Notes field in the source profile is lengthy but simple. The first icon designates a button for Linkages 1006; if the user selects this icon, a dialogue box is presented (see FIG. 11) which can be used to establish, inventory and effect connections to other files available on the user's computer or through network or internet links. The second and third icons are the Print/Print Preview pair. Then there is an array of conventional word processing and text formatting icons and selection boxes which can be used to shape the Notes field. Included in this array is a paste function icon 1008 which can be used to insert source material from other files. The last icon 1010 is the word/phrase search icon previously encountered in Sources screen.

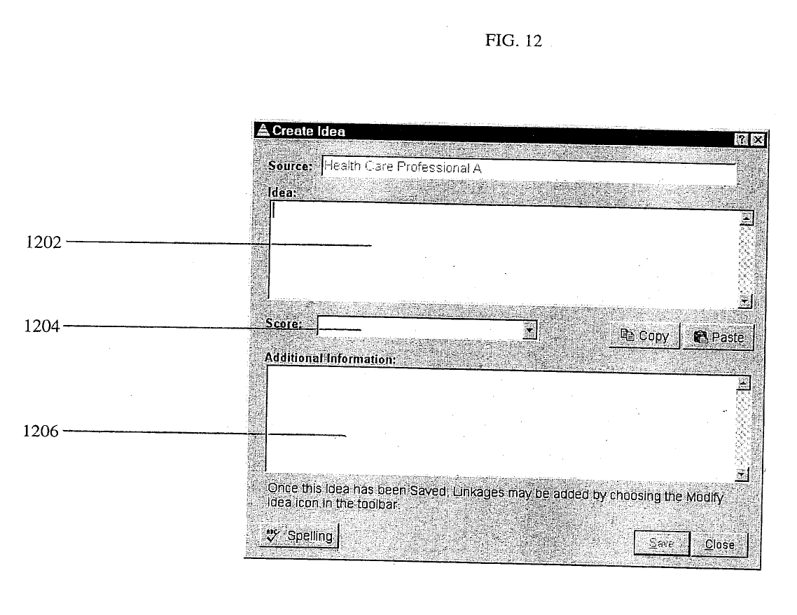

The threshold task of the user once a source has been created is to conduct inquiry and enter data in the Notes field. At any point in this task, the user may wish to enter in the Ideas field of the source profile one or more ideas that express key points found in the source material. The icons in the toolbar above the Ideas field give the user the familiar Create-Modify-Delete triad 1012, 1014, 1016 of options and the word/phrase search option 1018. A user who clicks on the Create Idea icon 1012 is presented with a dialogue box (see FIG. 12) having a field 1202 within which the idea can be entered and fields for the entry of the following ancillary items:

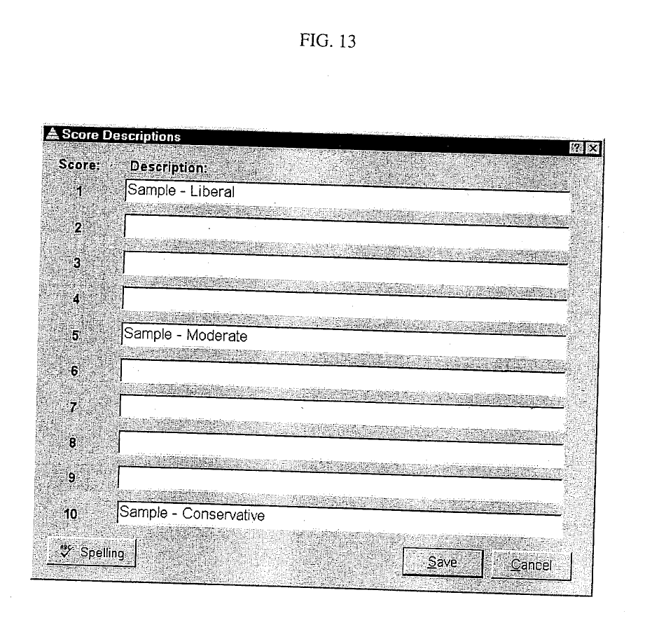

(a) Score 1204, which permits the entry of a score from 1 to 10 for the idea. The meaning of each number is set forth for each idea pyramid in a Score Descriptions dialogue box accessible under the Tools category in the program's standard menu bar near the top of all the working screens. See FIG. 13. The scores can mark off points on a single spectrum of meaning, or can be given wholly independent meanings in the Score Descriptions box which can then be used in conjunction with the sort-by-score mechanism referred to below 1512 to distinguish a variety of subsets within a group of ideas in the invention.

(b) Additional Information 1206, which permits supplemental text to be entered at any length.

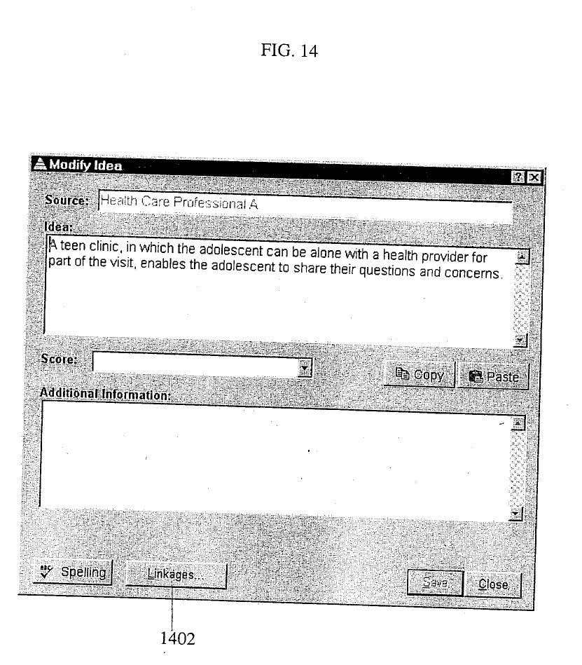

Once the idea has been created and become part of the source profile, the user can choose the icon for Modify Idea 1014 and receive access to a nearly identical dialogue box (see FIG. 14), but the program now adds a button 1402 which allows the user to create Linkages in the same way Linkages can be added to the Notes field of the source profile.

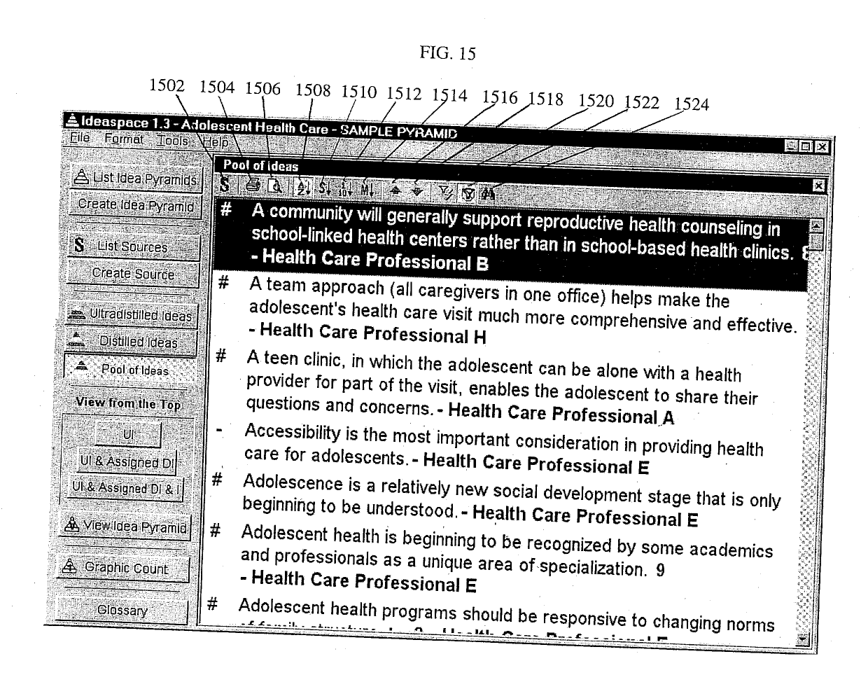

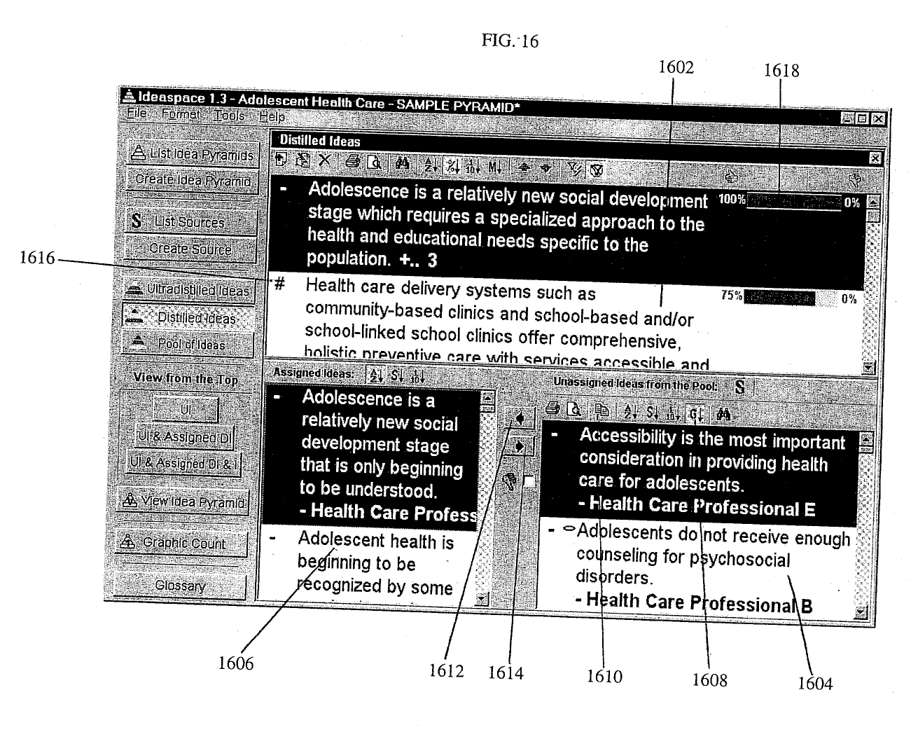

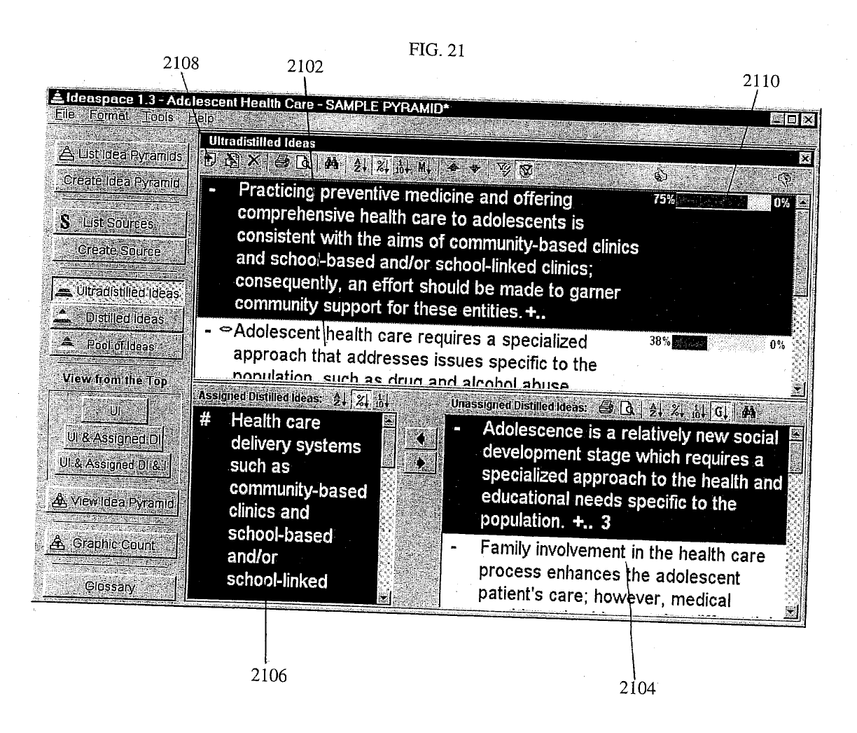

At the source profile level (FIG. 10) the invention lets the user enter as many ideas as the user wishes. There is also no limit on the number of sources, and consequently no limit on the size-of the pool of ideas (FIG. 15) which is composed of all the ideas from all the sources. Similarly, at the distilled ideas and ultradistilled ideas levels (FIGS. 16 and 21), the user can enter any number of distilled or ultradistilled ideas. At the source profile level, the ideas are ordered alphabetically by initial words. At all higher levels there are a variety of ordering options as discussed below.

There is no limit to the length of an idea or any requirement as to its grammatical form. Though the user may find that using single words or short phrases as “ideas” proves helpful in the early stages of inductive analysis and though the user may feel drawn to multiple sentences in the late stages, as the pyramid of thought grows, the most useful form for each idea will ordinarily be a single sentence setting forth a unitary concept. The discipline of the sentence form fosters completeness of thought and clarity of meaning, while hewing to a unitary concept within each sentence and avoiding multiple sentence ideas make it easier to sort and group the ideas so that patterns can be discerned and commonalties articulated. To optimally fuel the inductive process, a sentence fragment tends to have too little content and a multi-concept sentence or a group of sentences tends to have too much.

As the user enters more source data and composes ideas for each source, the dynamic features of the invention come into play. Referring to FIG. 15, within each idea pyramid, all of the ideas from all of the sources are continuously gathered into and listed in the pool of ideas (where each idea is tagged with the name of its source). The pool of ideas constitutes the raw materials for the distillation process that will yield the upper two levels of the pyramid. (Though the normal process of creating an idea pyramid will begin with the entry of data from multiple sources and the derivation of ideas for each source, the invention could also function in a more elemental way if a user wished to have a family of ideas drawn from a single source serve as the entire pool of ideas.)

The user can go to the pool of ideas by clicking on the sidebar button which bears its name 610. The toolbar near the top of the Pool of Ideas screen lets the user consider the ideas in the pool from a range of perspectives. The first icon 1502 permits the user who has highlighted an idea to go back to the source profile whence it came. The standard print and print preview icons 1504, 1506 are presented next. The next four icons all include downward arrows and give the user four different ways to sort the ideas in the field alphabetically by first word 1508, alphabetically by source 1510, by the score attributed to the ideas 1512 and by manual arrangement 1514. The up and down arrow icons 1516, 1518 which occur next are used for manual arrangement. The next two icons 1520, 1522 set or clear a filter that causes the screen to display only those ideas with a specified word or phrase, and the last one 1524 permits word or phrase searching.

When the user determines from scanning the pool of ideas that a body of information sufficiently rich for the user's purposes has been developed, the user is ready to begin building the upper layers of a pyramid of progressively distilled thought. The task of the user is to discern themes or commonalities in groups of ideas within the pool of ideas, then to compose distilled ideas which express those themes and assign the ideas in each thematic group to the respective distilled idea which expresses the theme of that group. The invention provides graphical structure and support for this process in two phases:

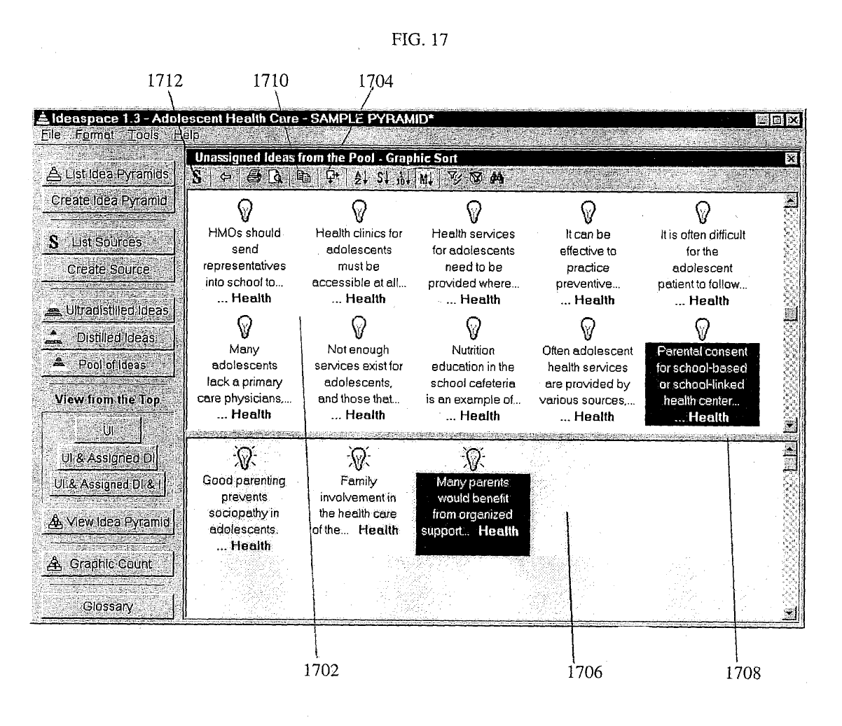

(a) Organizing the ideas into thematic groups. This is the precise function of the Graphic Sort screen (FIG. 17) described below and accessed through the Distilled Ideas screen (FIG. 16).

(b) Composing distilled ideas and associating each of them with the ideas in the thematic group whose theme the distilled idea expresses. These functions are carried out through the Distilled Ideas screen (FIG. 16).

To begin this phase of construction of the idea pyramid, the user goes to the Distilled Ideas screen (FIG. 16) by clicking on the appropriate button on the sidebar 608.

The Distilled Ideas screen dynamically juxtaposes three fields of information as shown in FIG. 16. The screen has an upper field in which the user can compose and list distilled ideas 1602 and two lower fields which are used to assign ideas from the pool of ideas to appropriate distilled ideas. The upper field has a toolbar containing icons with which the user will be growing familiar: create/modify/delete for distilled ideas; print and print preview; the same four sorting icons and three filtering/searching icons as in the pool of ideas. The lower right field 1604 presents to the user a grouping of all the ideas drawn from the pool of ideas which have not yet been assigned to a distilled idea. The contents of the lower left field 1606 vary depending on which distilled idea in the upper field has been selected and highlighted by clicking on it. When a distilled idea has been highlighted in the upper field 1602, the lower left field 1606 presents a grouping of all those ideas which have been assigned to, that is, associated with, the highlighted distilled idea. The toolbar for the lower left field offers several of the previously encountered sorting options to vary the display; the toolbar for the lower right field offers print/print preview, go to source profile, several familiar sorting options, and two functions not previously encountered-graphic sort 1608 and copy idea 1610, both of which are discussed below.

The assignment of an idea from the lower right field 1604 (made up of unassigned ideas from the pool) to the lower left field 1606 (made up of ideas assigned to a highlighted distilled idea) is accomplished by selecting (visually evidenced by highlighting) the unassigned idea and clicking on the left-pointing arrow 1612 located between the lower left and right fields. An idea moved in this fashion can, at the user's election, be moved back by highlighting the idea as it resides in field 1606 and clicking on the right-pointing arrow 1614, which returns the idea to the field of unassigned ideas. Dragging and clicking on the subject idea also works to transfer the idea in either direction. As the distillation process proceeds, more and more of the ideas originally drawn from the pool of ideas are assigned to the appropriate distilled ideas and the unassigned residuum in the lower right field gradually shrinks to nothing.

Each time an unassigned idea drawn from the pool of ideas is assigned to a distilled idea, a symbol (such as a #) 1616 appears at the beginning of the idea within the pool of ideas and within the source profile to indicate that such assignment has taken place. By noting the presence or absence of these symbols, the user can tell at a glance when viewing the pool of ideas or a source profile which of the baseline ideas have been assigned to distilled ideas.

The process of creating distilled ideas and assigning ideas to them which is carried out within the three fields of the Distilled Ideas screen can only go forward if the user is able to begin the process by discerning themes among the ideas and gathering the ideas into thematic groups. In recognition of the central importance and challenge of this process, the software provides a Graphic Sort screen (FIG. 17) devoted to the graphical organizing of the unassigned ideas into thematic groups. This Graphic Sort screen for unassigned ideas is accessed through the “G with arrow” icon 1608 in the unassigned ideas toolbar at the lower right of the Distilled Ideas screen.

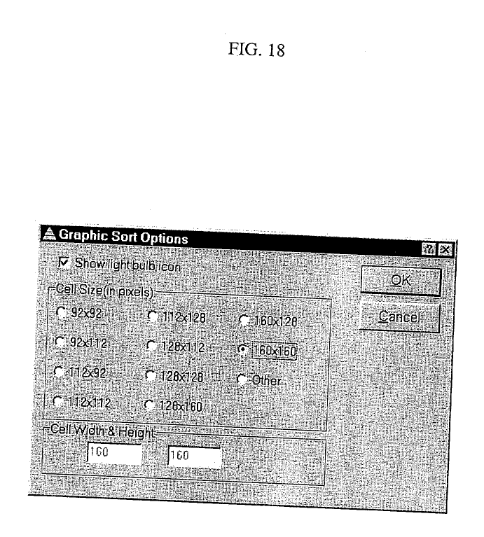

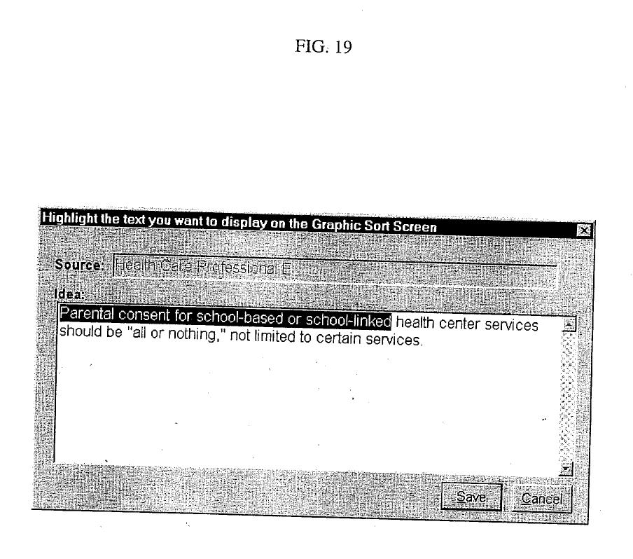

The Graphic Sort screen (FIG. 17) for unassigned ideas has an upper and a lower field. The upper field 1702 is filled with idea cells, one cell for each unassigned idea. Each cell includes a light bulb symbol, a portion of the text of the idea portrayed by the cell and the first word of the name of the source from whose source profile the idea comes. In the toolbar for this screen is an icon 1704 which yields a dialogue box (FIG. 18) that lets the user control the presence or absence of the light bulb symbol and the size of the cell. With larger cell size comes more text but a diminution in the number of cells visible in the field; the user strikes a balance. By double-clicking on a cell, the user brings up a dialogue box (FIG. 19) which shows the full text of the idea and permits the user to choose what portion of the idea will be presented in the cell, within the bounds established by cell size. The Graphic Sort screen toolbar also includes the searching and idea-arranging options which have been encountered in previous screens. Once the ideas in the upper field are satisfactorily presented, the user is ready to begin assembling thematic groups.

To thematically group ideas in the Graphic Sort screen, the user clicks on target ideas one at a time and drags them into the lower field 1706. Each idea deposited against the left-hand margin of the lower field will begin a new thematic group. Ideas can be added to the group by being deposited to the right of the last idea in line. If a group is long enough, it will wrap to the next line and indent to show continuation of the group from the line above. The size of the upper and lower fields can be varied by vertically moving with the cursor the bar 1708 which divides them; a scroll bar on the right side lets the user navigate up and down within each field as needed.

When ready to shift from the graphical organizing phase to the composing and associating phase, the user elects to return from the Graphic Sort screen to the Distilled Ideas screen and the thematic groupings assembled in the Graphic Sort screen are presented at the top of the Unassigned Ideas from the Pool field 1604 as groups set off from each other by a horizontal line and distinguished by alternating background colors. To compose a distilled idea, the user clicks on the Create Distilled Idea icon 2012, which opens a dialogue box similar to the Create Idea dialogue box shown in FIG. 12; as at the idea level, the user first composes the distilled idea, then can score it, add further information or create linkages.

A user may conclude that an idea logically belongs to more than one thematic group. The software permits the user to create copies of any such idea and to assign them to different groups. To make this a rigorous process, each such copied idea is labeled as a copy, and any modification of one copy modifies all. This copying function can be accessed through the “Copy Idea” icon (i) in the lower right field of the Distilled Ideas screen where unassigned ideas from the pool are presented 1610 and (ii) in the Graphic Sort screen for those unassigned ideas 1710. Clicking on this icon brings up a query box that checks to make sure the user wants to go forward with the copying. This feature can be extended to permit copying of distilled ideas.

A feature that supports thematic perception, creation of distilled ideas and work product review is offered in the toolbar for the Unassigned Ideas from the Pool-Graphic Sort screen 1712 and in two other places: (i) Unassigned Ideas from the Pool in the Distilled Ideas screen 1604 and (ii) Pool of Ideas 1502. This feature, which is accessed through the large “S” icon, permits the user to go to the source profile from which a highlighted idea came. The feature operates as a flashback; it takes the user back to an idea's home source profile to refresh the user's awareness of an idea's origins, then, when the user closes the source profile, it returns the user to the field from which the flashback was initiated. As this process occurs, there is continuity of idea selection, that is, the idea which was selected and thus visually highlighted in the screen from which the flashback was initiated will also be highlighted in the Source Profile screen and once again in the original screen when the flashback is concluded.

This same continuity of idea selection also operates for other screen shifts, both forward and back among the four working screens (FIGS. 10, 15, 16, 21) where ideas appear—Source Profiles, Pool of Ideas, Distilled Ideas and Unassigned Ideas from the Pool—Graphic Sort. The default presentation of the principal screens in the software is to show highlighting of the topmost entry in each list of ideas, distilled ideas or ultradistilled ideas; idea selection is accomplished by clicking on an idea, which causes it be highlighted if it is not already so, and which informs the computer that the idea has been selected. Continuity of idea selection means that, for instance, an idea selected and thus highlighted in the pool of ideas will remain selected and highlighted if the user goes back to the source profile, returns to the pool, navigates forward to the Distilled Ideas screen, then chooses the Unassigned Ideas from the Pool—Graphic Sort and finally goes back again to the source profile. However, in the example given, if the user then opts to shift to the Ultradistilled Ideas screen where no ideas from the pool appear, the continuity of selection will end. Continuity of idea selection is also provided for distilled ideas, so the user in this example could again invoke the feature by clicking on a distilled idea and having the highlighting of that idea continue upon a shift to the Distilled Ideas screen. Continuity of selection lasts as long as the selected idea or distilled idea is present in the screen chosen or until another item is selected.

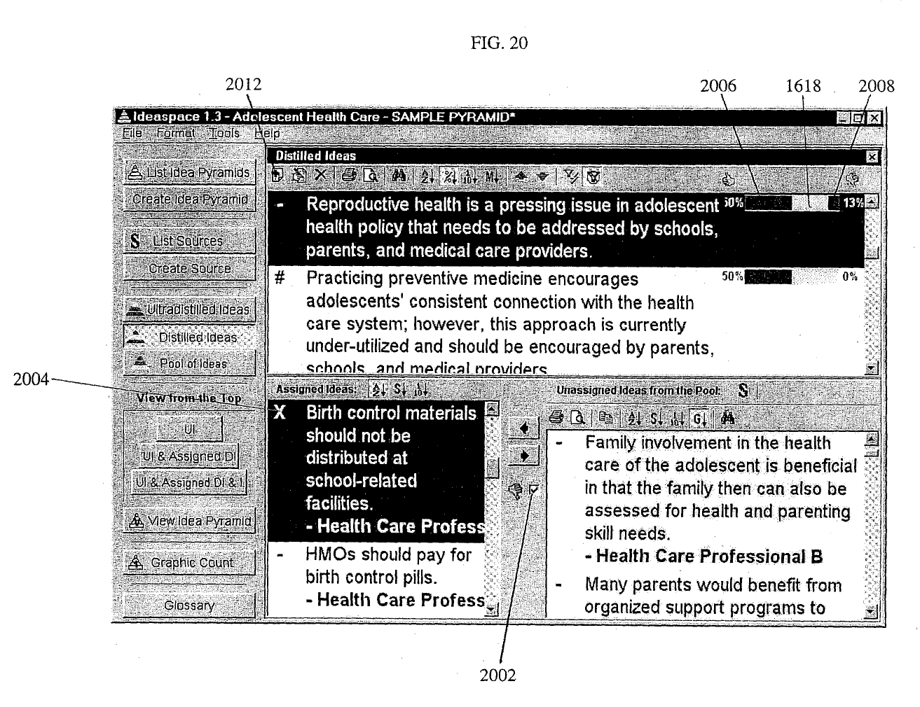

When an idea from the pool of ideas is assigned to a distilled idea, the default assumption of the software is that the assigned idea supports to some degree the distilled idea. The software also permits the user to opt against this assumption and specify that an assigned idea opposes the distilled idea to which it has been assigned. See FIGS. 16 and 20. To do this, the user selects the assigned idea once it has been placed within the lower left Assigned Ideas field 1606 in the Distilled Ideas screen and clicks on the “thumbs down” button 2002 in the space between the lower two fields, thereby flagging the selected idea with a red “X” 2004 at the beginning of the idea to show its opposition to the distilled idea to which it has been assigned.

As shown in FIGS. 16 and 20, a horizontal bar graph 1618 or other percentage indicator is presented to the right of each distilled idea in the Distilled Ideas screen. The graph shows the user on a continuous basis the percentage of all the sources in an idea pyramid that contributed a supporting idea to the thematic group which the user has assigned to a particular distilled idea and it also shows the percentage of all the sources in an idea pyramid that contributed an opposing idea to the group assigned to that distilled idea. This visual aid shows the user which distilled ideas enjoy broad support and which encounter opposition among the sources.

This bar graph 1618 shows both source support and source opposition in one graph by placing the bars at the opposite ends of the graph. See FIG. 20. Percentage of support for a distilled idea is shown as a green bar 2006 extending in to the right from the left-hand margin of the bar graph. Percentage of opposition is manifest as a red bar 2008 extending in to the left from the right-hand margin, but this bar appears only when at least one idea from the pool of ideas has been explicitly designated as opposing a distilled idea.

Automated data analysis of textual content can be provided to facilitate the recognition of patterns among ideas and distilled ideas and to suggest content for distilled and ultradistilled ideas. A potent application of the invention, limited only by the caliber of automated data analysis tools, will be the presentation of real time meta-pictures of qualitative data streams, such as chat room conversations. The invention offers a stable conceptual architecture though which a variety of artificial intelligence capabilities can be expressed.

Even with assistance from software embodying the invention, the idea distillation process described above is an intellectually challenging task. The reward in terms of revealed order can, however, be great.

A signal efficiency of the invention is that after the distillation process is applied to the pool of ideas to yield the distilled ideas, the identical thematic inquiry process is applied to the distilled ideas to yield the ultradistilled ideas. The user brings up the Ultradistilled Ideas screen (see FIG. 21) by clicking on the appropriate button on the sidebar 606.

At the ultradistilled level, three fields of information are once again dynamically juxtaposed—(i) an upper field 2102 where new ultradistilled ideas can be composed and listed, (ii) a lower right field 2104 presenting a grouping of all the distilled ideas which have not yet been assigned to an ultradistilled idea, and (iii) a lower left field 2106 in which appear, whenever an ultradistilled idea is highlighted in the upper field, a grouping of all the ideas which the user has drawn from the distilled ideas field and assigned to, that is, associated with, that particular ultradistilled idea. The toolbar icons are the same as those in the toolbar for the Distilled Ideas screen, except that the Ultradistilled Ideas screen does not have the Copy Idea option. New ultradistilled ideas are added by clicking on the Create Ultradistilled Idea icon 2108, which opens a dialogue box similar to the Create Idea dialogue box shown in FIG. 12 so that the user can compose an ultradistilled idea. If the inductive analysis is continuing to go well, each ultradistilled idea will express a theme or commonality present in those distilled ideas which the user selectively extracts from the lower right field and assigns to it. As the distillation process proceeds, the unassigned residuum in the lower right field gradually shrinks to nothing as' all the distilled ideas are assigned to ultradistilled ideas.

Each time an unassigned distilled idea is assigned to an ultradistilled idea, a symbol (such as a #) appears at the beginning of the distilled idea within the Ultradistilled Ideas screen and within the Distilled Ideas screen to indicate that such assignment has taken place. By noting the presence or absence of these symbols, the user can tell at a glance when viewing the Distilled Ideas screen which distilled ideas have been associated with ultradistilled ideas.

The same bar graph mechanism showing source support and opposition which is used in the Distilled Ideas screen is also present at the ultradistilled ideas level 2110 to show, by tracing back through the distilled ideas to the sources, the degree of support for and opposition (if any) to each ultradistilled idea. As discussed above, continuity of selection (and the consequent highlighting) prevails for distilled ideas as the user shifts among the screens for Ultradistilled Ideas, Distilled Ideas and Unassigned Distilled Ideas—Graphic Sort.

The pyramid can be enlarged to add additional idea levels beyond ultradistilled ideas. This will only be done if the gain in scope outweighs any loss of simplicity and clarity. The need for additional levels should be diminished in a networked environment where each idea pyramid can be readily linked to others to extend its analytical range toward the more abstract/general or the more concrete/particular.

The present invention is first a novel authoring tool, but there are also novel applications on the viewing side. An author whose idea pyramid is ready to be shared will be able to print a hard copy viewing the work product from a variety of perspectives or to post it as an electronic file on an internet or other network site. Viewers on the network who do not have the full authoring/viewing software package maybe allowed access to a program having some of the features of the present invention—for instance, having viewing and interactive functions but little or no authoring capacity. An author displaying an idea pyramid would be able to grant to network participants selective access for viewing or for such functions as commentary, polling, amendment, etc.

A valuable feature of the invention is that the user can affix to any source data or any of the ideas in an idea pyramid linkages to other electronically available data, including another idea pyramid. Through the linkage of one idea pyramid to another, a sea of comparably formatted information could grow that would expand without theoretical limit the potential breadth and depth of inquiry using this invention.

What is claimed is:

1. A method of organizing information and conducting thematic inquiry comprising the steps of:
listing ideas to form a pool of ideas;
graphically organizing the ideas into thematic groups; and
composing distilled ideas each of which expresses a theme found in one of the thematic groups of ideas and graphically associating the ideas in that one of the thematic groups with the distilled idea which expresses the theme in that one of the thematic groups.

2. A method as in claim 1, wherein each idea which is to be graphically organized is presented as text in a graphical cell whose size is controlled.

3. A method as in claim 2, wherein a portion of the text of each idea in a graphical cell is chosen for presentation in the cell.

4. A method as in claim 1, wherein an identical copy is created of an idea which is to be graphically organized and in the course of the graphical organization the idea and the copy are placed in different thematic groups.

5. A method as in claim 4, wherein if one of the idea and the copy is modified, the other of the idea and the copy is automatically modified in the same way and thus the idea and the copy remain identical.

6. A method as in claim 1, wherein an idea is graphically selected in a display and, as different displays are chosen, the graphical selection of the idea continues to be visible wherever the idea is encountered until that idea is no longer encountered or a different graphical selection is made.

7. A method as in claim 1, wherein the organizing of ideas into thematic groups and the composing of distilled ideas are aided by automated data analysis.

8. A method as in claim 1, wherein the distilled ideas are visually grouped, ideas in the pool of ideas which have not yet been associated with a distilled idea are visually grouped, ideas that have been associated with a distilled idea are visually grouped with other ideas that have been associated with the same distilled idea, and all three types of visual grouping are simultaneously viewed.

9. A method as in claim 1, further comprising the steps of:
graphically organizing the distilled ideas into thematic groups; and
composing ultradistilled ideas each of which expresses a theme found in one of the thematic groups of distilled ideas and graphically associating the distilled ideas in that one of the thematic groups with the ultradistilled idea which expresses the theme in that one of the thematic groups.

10. A method as in claim 9, wherein the ultradistilled ideas are visually grouped, distilled ideas which have not yet been associated with an ultradistilled idea are visually grouped, distilled ideas that have been associated with an ultradistilled idea are visually grouped with other distilled ideas that have been associated with the same ultradistilled idea, and all three types of visual grouping are simultaneously viewed.

11. A method as in claim 9, further comprising the step of associating one or more ideas in the pool with a named source of that idea and data relating to that source.

12. A method as in claim 11, further comprising the step of visually grouping as a source profile all of the source data and the ideas associated with the respective source.

13. A method as in claim 12, wherein the ultradistilled ideas, the distilled ideas, the pool of ideas and the source profiles are visually presented as forming a pyramidal unit.

14. A method as in claims 13, wherein the pyramidal unit is presented as a pyramid of progressively distilled thought in which the distillation process extracts a more abstract and succinct apex from a more detailed and inclusive bottom layer of ideas which are drawn from a base of source material.

15. A method as in claim 13, further comprising the step of linking sources, source data, ideas, distilled ideas, or ultradistilled ideas with other information.

16. A method as in claim 13, wherein multiple users participate in any of the recited steps by providing commentary, voting, or suggesting sources, source data, ideas, distilled ideas, or ultradistilled ideas.

17. A method as in claim 11, further comprising the step of displaying a graphic representation showing for a distilled idea what portion of all the sources are associated with that distilled idea in a supportive way.

18. A method as in claim 17, further comprising the step of displaying a graphic representation showing for a distilled idea what portion of all the sources are associated with that distilled idea in an oppositional way.

19. A method as in claim 17, wherein the distilled ideas are ordered and displayed according to the size of the portion of all the sources which are associated with that idea in a supportive way.

20. A method as in claim 11, further comprising the step of displaying a graphic representation showing for an ultradistilled idea what portion of all sources are associated via the distilled ideas with that ultradistilled idea in a supportive way.

21. A method as in claim 20, further comprising the step of displaying a graphic representation showing for an ultradistilled idea what portion of all sources are associated via the distilled ideas with that ultradistilled idea in an oppositional way.

22. A method as in claim 9, wherein automated data analysis is employed to provide an evolving conceptual picture of a stream of data.

23. A method as in claim 9, further comprising the step of displaying in a single field all of the ultradistilled ideas, all of the distilled ideas which are associated with an ultradistilled idea and all of the ideas in the pool of ideas which are associated with a distilled, ideas which is associated with an ultradistilled ideas such that the distilled ideas are disposed adjacent to the ultradistilled ideas with which the distilled ideas are associated and the ideas are disposed adjacent to the distilled ideas with which the ideas are associated.

24. A method as in claim 23, further comprising the step of presenting the display of ultradistilled ideas and their associated distilled ideas and the ideas from the pool of ideas which are associated with the distilled ideas which are associated with ultradistilled ideas as a view from the top of a pyramid of progressively distilled thought.

25. A method as in claim 23, further comprising the steps of hiding or revealing associated ideas disposed adjacent to a distilled idea and of hiding or revealing distilled ideas together with any revealed associated ideas disposed adjacent to an ultradistilled idea.

26. An apparatus for organizing information and conducting thematic inquiry with software that comprises:
means for listing ideas to form a pool of ideas;
means for graphically organizing the ideas into thematic groups; and
means for listing distilled ideas each of which expresses a theme found in one of the thematic groups of ideas and graphically associating the ideas in that one of the thematic groups with the distilled idea which expresses the theme in that one of the thematic groups.

27. An apparatus as in claim 26, wherein the means for graphically organizing the ideas into thematic groups comprises means for presenting each idea which is to be graphically organized as text in a graphical cell whose size is controlled.

28. An apparatus as in claim 27, wherein the means for presenting each graphical cell containing an idea which is to be graphically organized comprises means for choosing a portion of the text of each idea for presentation in the cell.

29. An apparatus as in claim 26, wherein the means for graphically organizing ideas comprises means for creating an identical copy of an idea which is to be graphically organized and in the course of the graphical organization the idea and the copy are placed in different thematic groups.

30. An apparatus as in claim 29, wherein if one of the idea and the copy is modified, the other of the idea and the copy is automatically modified in the same way and thus the idea and the copy remain identical.

31. An apparatus as in claim 26, further comprising means for graphically selecting an idea in a display such that, as different displays are chosen, the graphical selection of the idea continues to be visible wherever the idea is encountered until that idea is no longer encountered or a different graphical selection is made.

32. An apparatus as in claim 26, wherein the means for organizing ideas into thematic groups and listing distilled ideas is aided by automated data analysis of textual content of the ideas.

33. An apparatus as in claim 26, wherein the means for listing distilled ideas comprises means for displaying simultaneously a field listing the distilled ideas, a field displaying ideas from the pool which are associated with any selected one of the distilled ideas, and a field displaying ideas from the pool that have not yet been associated with one of the distilled ideas.

34. An apparatus as in claim 26, further comprising:
means for graphically organizing the distilled ideas into thematic groups; and
means for listing ultradistilled ideas each of which expresses a theme found in one of the thematic groups of distilled ideas and graphically associating the distilled ideas in that one of the thematic groups with the ultradistilled idea which expresses the theme in that one of the thematic groups.

35. An apparatus as in claim 34, wherein the means for listing ultradistilled ideas comprises means for displaying simultaneously a field listing the ultradistilled ideas, a field displaying distilled ideas which are associated with any selected one of the ultradistilled ideas, and a field displaying distilled ideas that have not yet been associated with one of the distilled ideas.

36. An apparatus as in claim 34, further comprising means for associating one or more ideas in the pool with a named source of the idea and data relating to that source.

37. An apparatus as in claim 36, further comprising means of visually grouping as a source profile all of the source data and the ideas associated with the respective source.

38. An apparatus as in claim 37, wherein the ultradistilled ideas, the distilled ideas, the pool of ideas and the source profiles are visually presented as forming a pyramidal unit.

39. An apparatus as in claim 38, wherein the pyramidal unit is presented as a pyramid of progressively distilled thought in which the distillation process extracts a more abstract and succinct apex from a more detailed and inclusive bottom layer of ideas which are drawn from a base of source material.

40. An apparatus as in claim 38, further comprising means of linking sources, source data, ideas, distilled ideas, or ultradistilled ideas with other information.

41. An apparatus as in claim 38, further comprising means for permitting multiple user participation in any of the recited steps by providing commentary, voting, or suggesting sources, source data, ideas, distilled ideas, or ultradistilled ideas.

42. An apparatus as in claim 36, further comprising means for displaying a graphic representation showing for one or more of the distilled ideas what portion of all the sources is associated with a particular distilled idea in a supportive way.

43. An apparatus as in claim 42, further comprising means for displaying a graphic representation showing for one or more of the distilled ideas what portion of all the sources is associated with a particular distilled idea in an oppositional way.

44. An apparatus as in claim 42, wherein the means for displaying the graphic representation of the portion of sources that is associated with a distilled idea in a supportive way comprises means for displaying the distilled ideas according to the size of the portion of associated sources that is supportive.

45. An apparatus as in claim 36, further comprising means for displaying a graphic representation showing for one or more of the ultradistilled ideas what portion of all sources are associated via the distilled ideas with a particular ultradistilled idea in a supportive way.

46. An apparatus as in claim 45, further comprising means for displaying a graphic representation showing for one or more of the ultradistilled ideas what portion of all sources are associated via the distilled ideas with a particular ultradistilled idea in an oppositional way.

47. An apparatus as in claim 34, wherein automated data analysis is employed to provide an evolving conceptual picture of a stream of data.

48. An apparatus as in claim 34, further comprising means for displaying in a single field all of the ultradistilled ideas, all of the distilled ideas which are associated with an ultradistilled idea and all of the ideas in the pool of ideas which are associated with a distilled ideas which is associated with an ultradistilled ideas such that the distilled ideas are disposed adjacent to the ultradistilled ideas with which the distilled ideas are associated and the ideas are disposed adjacent to the distilled ideas with which the ideas are associated.

49. An apparatus as in claim 48, further comprising means for presenting the display of ultradistilled ideas and their associated distilled ideas and the ideas from the pool of ideas which are associated with the distilled ideas which are associated with ultradistilled ideas as a view from the top of a pyramid of progressively distilled thought.

50. An apparatus as in claim 48, further comprising means for hiding or revealing associated ideas disposed adjacent to a distilled idea and for hiding or revealing distilled ideas together with any revealed associated ideas disposed adjacent to an ultradistilled idea.

51. A method of organizing information and conducting thematic inquiry comprising the steps of:
listing ideas to form a pool of ideas;
composing distilled ideas and associating ideas in the pool with a distilled idea, wherein each distilled idea expresses a theme common to those ideas from the pool that are associated with said distilled idea; and
composing ultradistilled ideas and associating distilled ideas with an ultradistilled idea, wherein each ultradistilled idea expresses a theme common to those distilled ideas that are associated with said ultradistilled idea.

52. A method as in claim 51, wherein the distilled ideas are visually grouped, ideas in the pool of ideas which have not yet been associated with a distilled idea are visually grouped, ideas that have been associated with a distilled idea are visually grouped with other ideas that have been associated with the same distilled idea, and all three types of visual grouping can be simultaneously viewed.

53. A method as in claim 51, wherein an identical copy is created of an idea which is to be visually grouped and in the course of the visual grouping the idea and the copy of the idea are placed in different thematic groups.

54. A method as in claim 53, wherein if one of the idea and the copy is modified, the other of the idea and the copy is automatically modified in the same way and thus the idea and the copy remain identical.

55. A method as in claim 51, wherein the ultradistilled ideas are visually grouped, distilled ideas which have not yet been associated with an ultradistilled idea are visually grouped, distilled ideas that have been associated with an ultradistilled idea are visually grouped with other distilled ideas that have been associated with the same ultradistilled idea, and all three types of visual grouping can be simultaneously viewed.

56. A method as in claim 51, further comprising the step of associating one or more ideas in the pool with a named source of that idea and data relating to that source.

57. A method as in claim 56, further comprising the step of visually grouping as a source profile all of the source data and the ideas associated with the respective source.

58. A method as in claim 57, wherein the ultradistilled ideas, the distilled ideas, the pool of ideas and the source profiles are visually presented as forming a pyramidal unit.

59. A method as in claim 58, wherein the pyramidal unit is presented as a pyramid of progressively distilled thought in which the distillation process extracts a more abstract and succinct apex from a more detailed and inclusive bottom layer of ideas which are drawn from a base of source material.

60. A method as in claim 58, further comprising the step of linking sources, source data, ideas, distilled ideas, or ultradistilled ideas with other information.

61. A method as in claim 58, wherein multiple users participate in any of the recited steps by providing commentary, voting, or suggesting sources, source data, ideas, distilled ideas, or ultradistilled ideas.

62. A method as in claim 56, further comprising the step of displaying a graphic representation showing for a distilled idea what portion of all the sources are associated with that distilled idea in a supportive way.

63. A method as in claim 62, further comprising the step of displaying a graphic representation showing for a distilled idea what portion of all the sources are associated with that distilled idea in an oppositional way.

64. A method as in claim 62, wherein the distilled ideas are ordered and displayed according to the size of the portion of all the sources which are associated with that idea in a supportive way.

65. A method as in claim 56, further comprising the step of displaying a graphic representation showing for an ultradistilled idea what portion of all sources are associated via the distilled ideas with that ultradistilled idea in a supportive way.

66. A method as in claim 65, further comprising the step of displaying a graphic representation showing for an ultradistilled idea what portion of all sources are associated via the distilled ideas with that ultradistilled idea in an oppositional way.

67. A method as in claim 51, wherein an idea is graphically selected in a display and, as different displays are chosen, the graphical selection of the idea continues to be visible wherever the idea is encountered until that idea is no longer encountered or a different graphical selection is made.

68. A method as in claim 51, wherein the composing of distilled ideas is aided by automated data analysis.

69. A method as in claim 51, wherein automated data analysis is employed to provide an evolving conceptual picture of a stream of data.

70. A method as in claim 51, further comprising the step of displaying in a single field all of the ultradistilled ideas, all of the distilled ideas which are associated with an ultradistilled idea and all of the ideas in the pool of ideas which are associated with a distilled ideas which is associated with an ultradistilled ideas such that the distilled ideas are disposed adjacent to the ultradistilled ideas with which the distilled ideas are associated and the ideas are disposed adjacent to the distilled ideas with which the ideas are associated.

71. A method as in claim 70, further comprising the step of presenting the display of ultradistilled ideas and their associated distilled ideas and the ideas from the pool of ideas which are associated with the distilled ideas which are associated with ultradistilled ideas as a view from the top of a pyramid of progressively distilled thought.

72. A method as in claim 70, further comprising the steps of hiding or revealing associated ideas disposed adjacent to a distilled idea and of hiding or revealing distilled ideas together with any revealed associated ideas disposed adjacent to an ultradistilled idea.

73. An apparatus for organizing information and conducting thematic inquiry with software that comprises:
means for listing ideas to form a pool of ideas;
means for listing distilled ideas and associating ideas in the pool with a distilled idea, wherein each distilled idea expresses a theme common to those ideas from the pool that are associated with said distilled idea; and
means for listing ultradistilled ideas and associating distilled ideas with an ultradistilled idea, wherein each ultradistilled idea expresses. a theme common to those distilled ideas that are associated with said ultradistilled idea.

74. An apparatus as in claim 73, wherein the means for listing distilled ideas comprises means for displaying simultaneously a field listing the distilled ideas, a field displaying ideas from the pool which are associated with any selected one of the distilled ideas, and a field displaying ideas from the pool that have not yet been associated with one of the distilled ideas.

75. An apparatus as in claim 73; wherein an identical copy is created of an idea which is to be visually grouped and in the course of the visual grouping the idea and the copy of the idea are placed in different thematic groups.

76. An apparatus as in claim 73, wherein if one of the idea and the copy is modified, the other of the idea and the copy is automatically modified in the same way and thus the idea and the copy remain identical.

77. An apparatus as in claim 73, wherein the means for listing ultradistilled ideas comprises means for displaying simultaneously a field listing the ultradistilled ideas, a field displaying distilled ideas which are associated with any selected one of the ultradistilled ideas, and a field displaying distilled ideas that have not yet been associated with one of the distilled ideas.

78. An apparatus as in claim 73, further comprising means for associating one or more ideas in the pool with a named source of the idea and data related to that source.

79. An apparatus as in claim 78, further comprising means of visually grouping as a source profile all of the source data and the ideas associated with the respective source.

80. An apparatus as in claim 79, wherein the ultradistilled ideas, the distilled ideas, the pool of ideas and the source profiles are visually presented as forming a pyramidal unit.

81. An apparatus as in claim 80, wherein the pyramidal unit is presented as forming a pyramid of progressively distilled thought in which the distillation process extracts a more abstract and succinct apex from a more detailed and inclusive bottom layer of ideas which are drawn from a base of source material.

82. An apparatus as in claim 80, further comprising means of linking sources, source data, ideas, distilled ideas, or ultradistilled ideas with other information.

83. An apparatus as in claim 80, further comprising means for permitting multiple user participation in any of the recited steps by providing commentary, voting, or suggesting sources, source data, ideas, distilled ideas, or ultradistilled ideas.

84. An apparatus as in claim 78, further, comprising means for displaying a graphic representation showing for one or more of the distilled ideas what portion of all the sources are associated with a particular distilled idea in a supportive way.

85. An apparatus as in claim 84, further comprising means for displaying a graphic representation showing for one or more of the distilled ideas what portion of all the sources are associated with a particular distilled idea in an oppositional way.

86. An apparatus as in claim 84, wherein the means for displaying the graphic representation of the portion of sources that is associated with a distilled idea in a supportive way-comprises means for displaying the distilled ideas according to the size of the portion of associated sources that is supportive.

87. An apparatus as in claim 78, further comprising means for displaying a graphic representation showing for one or more of the ultradistilled ideas what portion of all sources are associated via the distilled ideas with a particular ultradistilled idea in a supportive way.

88. An apparatus as in claim 87, further comprising means for displaying a graphic representation showing for one or more of the ultradistilled ideas what portion of all sources are associated via the distilled ideas with a particular ultradistilled idea in an oppositional way.

89. An apparatus as in claim 73, wherein an idea is graphically. selected in a display and, as different displays are chosen, the graphical selection of the idea continues to be visible wherever the idea is encountered until that idea is no longer encountered or a different graphical selection is made.

90. An apparatus as in claim 73, wherein the means for listing distilled ideas is aided by automated data analysis of textual content of the ideas.

91. An apparatus as in claim 73, wherein automated data analysis is employed to provide an evolving conceptual picture of a stream of data.

92. An apparatus as in claim 73, further comprising means for displaying in a single field all of the ultradistilled ideas, all of the distilled ideas which are associated with an ultradistilled idea and all of the ideas in the pool of ideas which are associated with a distilled ideas which is associated with an ultradistilled ideas such that the distilled ideas are disposed adjacent to the ultradistilled ideas with which the distilled ideas are associated and the ideas are disposed adjacent to the distilled ideas with which the ideas are associated.

93. An apparatus as in claim 92, further comprising means for presenting the display of ultradistilled ideas and their associated distilled ideas and the ideas from the pool of ideas which are associated with the distilled ideas which are associated with ultradistilled ideas as a view from the top of a pyramid of progressively distilled thought.

94. An apparatus as in claim 92, further comprising means for hiding or revealing associated ideas disposed adjacent to a distilled idea and for hiding or revealing distilled ideas together with any revealed associated ideas disposed adjacent to an ultradistilled idea.
